(19) United States
(12) Patent Application Publication
(10) Pub. No.: US 2011/0022724 A1
(43) Pub. Date: Jan. 27, 2011

(54) COMMUNICATION TERMINAL THAT PERFORMS DATA TRANSMISSION USING SIP, COMMUNICATION METHOD, AND STORAGE MEDIUM

(75) Inventor: Makoto FUKUMIZU, Matsudo-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/842,632

(22) Filed: Jul. 23, 2010

(30) Foreign Application Priority Data
Jul. 23, 2009 (JP) 2009-172208

(51) Int. Cl. G06F 15/173; G06F 11/07

(52) U.S. Cl. 709/238; 714/4; 714/E11.023

(57) ABSTRACT

A communication terminal which is capable of preventing a user of a terminal that receives data from being confused when a redirect setting is made after occurrence of an error during data transmission and before resuming the data transmission. A communication terminal performs data transmission using SIP. A CPU of the terminal determines, based on address information received before resuming the data transmission, whether or not a redirect setting has been made after occurrence of an error during data transmission. The CPU performs data transmission to a terminal of a redirect destination, starting from a first page, in a case where when resuming the data transmission, it is determined that the redirect setting has been made.

### BACKGROUND OF THE INVENTION

1. Field of the Invention

The present invention relates to a communication terminal that performs data communication using e.g. SIP (Session Initiation Protocol) as a communication control protocol, and a communication method.

2. Description of the Related Art

In a case where communication is performed using SIP, a SIP server is provided between a source terminal and a destination terminal, and the source terminal queries the SIP server as to the IP address of the destination terminal to thereby acquire the IP address and request the destination terminal to be connected therewith.

Under the above-mentioned communication environment, the destination terminal can make a redirect setting in the SIP server (see Japanese Patent Laid-Open Publication No. 2005-94662).

The redirect setting is made e.g. when a user of the destination terminal on the receiving side has to go out and desires to receive data addressed to the user not by the user's normal destination terminal, but by a terminal outside the user's house or office while he is out. In this case, the user registers an IP address of the terminal outside the user's house or office as a redirect destination in the SIP server in advance. Then, upon receipt of a query from a source terminal, the SIP server notifies the source terminal of the IP address of the redirect destination terminal.

Among communication terminals including a facsimile machine, there is one equipped with an error redial function (see Japanese Patent Laid-Open Publication No. H01-290372). The error redial function is a function that when communication is interrupted due to occurrence of an error during data transmission, the source terminal calls the destination terminal again to thereby resume the data transmission from a page being transmitted at the time of occurrence of the error.

By the way, it can occur that when an error is caused during data transmission, the above-mentioned redirect setting is made in the SIP in timing after occurrence of the error and before resuming the data transmission starting from the page transmission of which was interrupted. In this case, when the data transmission is resumed by the error redial function, the remaining pages for transmission are transmitted to a redirect destination terminal which is different from an original destination terminal to which data was transmitted before the occurrence of the error, which confuses a user on the receiving side.

### SUMMARY OF THE INVENTION

The present invention provides a communication terminal which is capable of preventing a user of a terminal that receives data from being confused when a redirect setting is made after occurrence of an error during data transmission and before resuming the data transmission, a communication method, and a non-transitory computer-readable storage medium storing a program for causing a computer to execute the communication method.

In a first aspect of the present invention, there is provided a communication terminal that performs data transmission using a session initiation protocol, comprising a determination unit adapted to determine, based on address information received before resuming the data transmission, whether or not a redirect setting has been made after occurrence of an error during data transmission, and a control unit adapted to transmit data to a terminal of a redirect destination of the data transmission, starting from a first page, in a case where when resuming the data transmission, the determination unit determines that the redirect setting has been made.

In a second aspect of the present invention, there is provided a communication terminal which performs data transmission using a session initiation protocol, comprising a determination unit adapted to determine, based on address information received before resuming the data transmission, whether or not a redirect setting has been made after occurrence of an error during data transmission, a control unit adapted to transmit data to a terminal of a redirect destination of the data transmission, starting from a page next to completely transmitted pages, in a case where when resuming the data transmission, the determination unit determines that the redirect setting has been made, a first notification unit adapted to be operable when the control unit has transmitted the data to the terminal of the redirect destination of the data transmission, starting from the page next to the completely transmitted pages, to notify the terminal of the redirect destination of the data transmission that data of preceding pages has been transmitted to a terminal of an immediately preceding destination of the data transmission, and a second notification unit adapted to be operable when the control unit has transmitted the data to the terminal of the redirect destination of the data transmission, starting from the page next to the completely transmitted pages, to notify the terminal of the immediately preceding destination of the data transmission that data of following pages has been transmitted to the terminal of the redirect destination of the data transmission.

In a third aspect of the present invention, there is provided a communication terminal that performs data transmission using a session initiation protocol, comprising a determination unit adapted to determine, based on address information received before resuming the data transmission, whether or not a redirect setting has been made after occurrence of an error during data transmission, a control unit adapted to transmit data to a terminal of an immediately preceding destination of the data transmission, starting from a page next to completely transmitted pages, in a case where when resuming the data transmission, the determination unit determines that the redirect setting has been made, and a notification unit adapted to be operable when the control unit has transmitted the data to the terminal of the immediately preceding destination of the data transmission, starting from the page next to the completely transmitted pages, to notify a terminal of a redirect destination of the data transmission that data of following pages has been transmitted to the terminal of the immediately preceding destination of the data transmission.

According to the present invention, it is possible to prevent a user of a terminal that receives data from being confused when a redirect setting is made after occurrence of an error during data transmission and before resuming the data transmission.

Further features of the present invention will become apparent from the following description of exemplary embodiments with reference to the attached drawings.

### BRIEF DESCRIPTION OF THE DRAWINGS

FIG. 1 is a schematic diagram of a communication system including a communication terminal according to a first embodiment of the present invention.

FIG. 2 is a block diagram of an MFP-X as the communication terminal according to the first embodiment.

FIGS. 3A and 3B are a flowchart of a data transmission process executed by the MFP-X, including a transmission process executed when a redirect setting is made after occurrence of an error during data transmission and before resuming the data transmission.

FIG. 4 is a sequence diagram useful in explaining processing executed by the MFP-X, for receiving a redirect setting status from the SIP server and transmitting the data to a redirect destination of the data transmission, starting from the first page.

FIG. 5 is a flowchart of a process executed by the MFP-X, for notifying an MFP-A which is the immediately preceding destination of the data transmission that the MFP-X has transmitted the data to an MFP-B which is a redirect destination of the data transmission, starting from the first page.

FIG. 6 is a sequence diagram useful in explaining processing executed for notifying the MFP-A which is the immediately preceding destination of the data transmission from the MFP-X that the MFP-X has transmitted the data to the MFP-B which is the redirect destination, starting from the first page.

FIGS. 7A and 7B are a flowchart of a transmission process executed by an MFP-X as a communication terminal according to a second embodiment of the present invention, including a transmission process executed when a redirect setting is made after occurrence of an error during data transmission and before resuming the data transmission.

FIGS. 8A and 8B are a flowchart of a transmission process executed by an MFP-X as a communication terminal according to a third embodiment of the present invention, including a transmission process executed when a redirect setting is made after occurrence of an error during data transmission and before resuming the data transmission.

FIG. 9 is a sequence diagram useful in explaining processing executed for transmitting data from the MFP-X to the MFP-A which is the immediately preceding destination of the data transmission, starting from a page next to the completely transmitted pages, when a redirect setting is made after occurrence of an error during data transmission and before resuming the data transmission.

FIG. 10 is a flowchart of a process executed by the MFP-X, for notifying the MFP-B which is the redirect destination from the MFP-X that the data has been transmitted to the MFP-A which is the immediately preceding destination of the data transmission, starting from a page next to the completely transmitted pages.

FIG. 11 is a sequence diagram useful in explaining processing executed for notifying the MFP-B which is the redirect destination from the MFP-X that the data has been transmitted to the MFP-A which is the immediately preceding destination of the data transmission, starting from a page next to the completely transmitted pages.

FIGS. 12A and 12B are a flowchart useful in explaining an example of the operation of an MFP-X as a communication terminal according to a fourth embodiment of the present invention.

FIG. 13 is a view illustrating an example of a setting screen.

### DETAILED DESCRIPTION OF THE EMBODIMENTS

The present invention will now be described in detail below with reference to the accompanying drawings showing embodiments thereof.

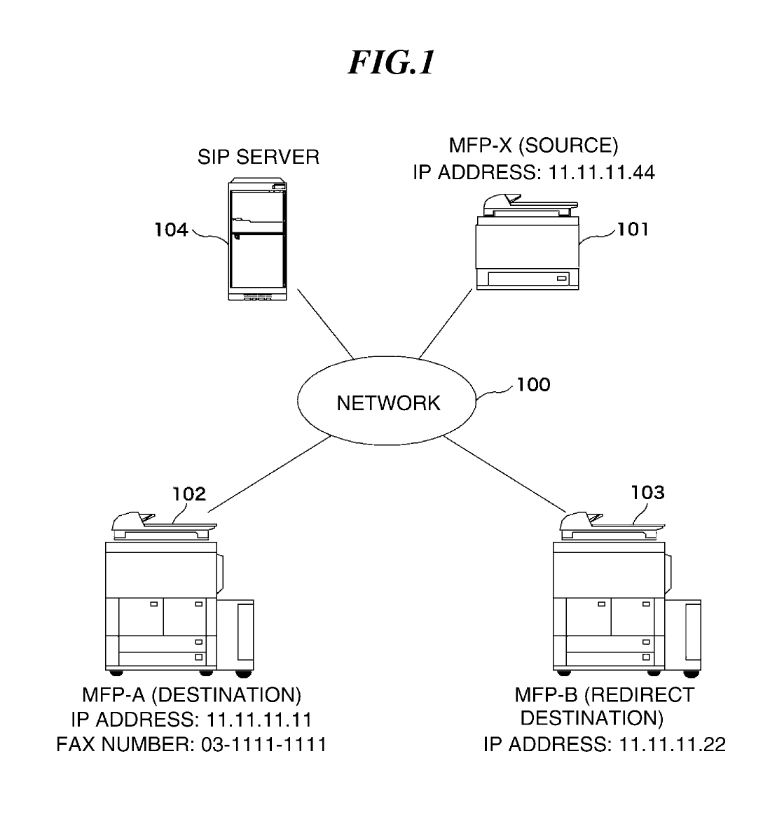

FIG. 1 is a schematic diagram of a communication system including a communication terminal according to a first embodiment of the present invention.

In the communication system shown in FIG. 1, an MFP (Multifunction Peripheral)-X 101, an MFP-A 102, an MFP-B 103, and a SIP server 104 each capable of performing data communication using SIP (Session Initiation Protocol) are interconnected via a network (communication line) 100.

The MFP-X 101, the MFP-A 102, and the MFP-B 103 are each equipped with a copy function, a FAX function, and a printing function.

Further, in the illustrated communication system, it is assumed that the MFP-X 101 is a source terminal, the MFP-A 102 is a destination terminal, and the MFP-B 103 is a redirect destination terminal. In the present embodiment, the MFP-X 101 corresponds to an example of the communication terminal according to the present invention. It should be noted that the MFP-A 102 is assigned a FAX number “03-1111-1111”.

The SIP server 104 is a combination of a redirect server, a proxy server, a registration server, and a location server, none of which are particularly shown. Further, the SIP server 104 performs the management of registration of each terminal, user authentication, the conversion of a telephone or FAX number to address information such as an IP address, the control of a call control sequence, routing to a connection destination, and so forth.

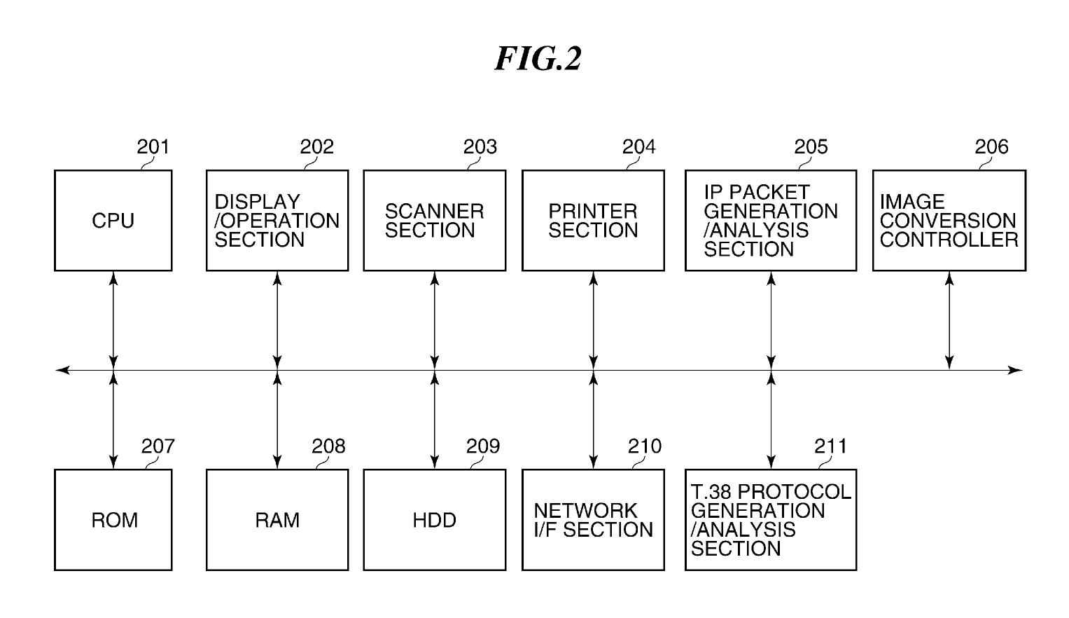

FIG. 2 is a block diagram useful in explaining an example of the configuration of the MFP-X 101. The configurations of the MFP-A 102 and the MFP-B 103 are the same as that of the MFP-X 101, and hence description thereof is omitted.

Referring to FIG. 2, a CPU 201 controls each component device of the MFP-X 101 based on a control program stored in a ROM 207.

A display/operation section 202 displays e.g. windows, icons, messages, menus, and other user interface information, on a display screen thereof. The display/operation section 202 comprises various kinds of keys, not shown, via which the user performs an operation for copying, FAX transmission and printing, and a screen pointing device, not shown, by which the user operates an icon, a menu, etc. displayed on the display screen.

A scanner section 203 reads an image from an original. A printer section 204 prints out print data stored in a RAM (Random Access Memory) 208 or a HDD (Hard Disk Drive) 209. The ROM (Read Only Memory) 207 stores various kinds of control programs and data.

The RAM 208 has a work area for the CPU (Central Processing Unit) 201, a data save area for use in error handling, a load area for loading control programs, etc. The HDD 209 stores various kinds of control programs and print data.

A network interface (I/F) section 210 is connected to the network 100, and performs communication with the SIP server 104, the MFP-A 102, and the MFP-B 103. The network interface section 210 also performs communication for SIP-FAX.

A T.38 protocol generation/analysis section 211 has the function of generating FAX transmission information that is to be transmitted according to a protocol defined by ITU-T (International Telecommunication Union Telecommunication Standardization Sector) Recommendation T.38, and further extracting FAX transmission information from a received protocol.

An IP packet generation/analysis section 205 has the function of mapping the protocol defined in ITU-U Recommendation T.38 to IP packets, and further extracting the protocol defined in the ITU-UT Recommendation T.38 from received IP packets. An image conversion controller 206 performs the compression, expansion, zooming and linear density conversion of images to be transmitted and received by FAX communication.

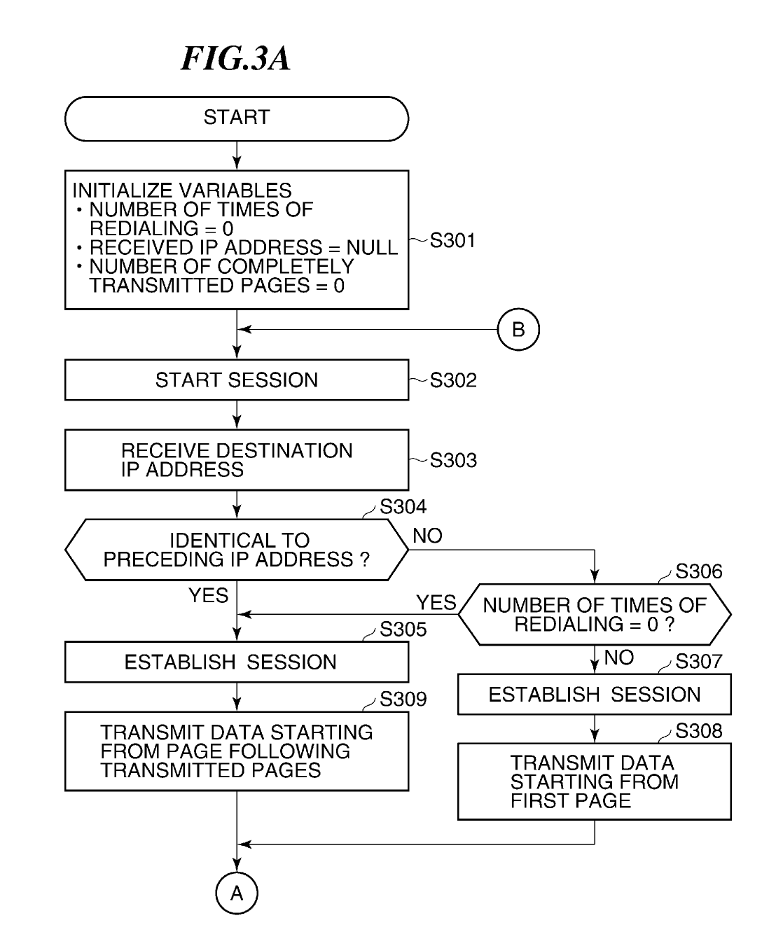

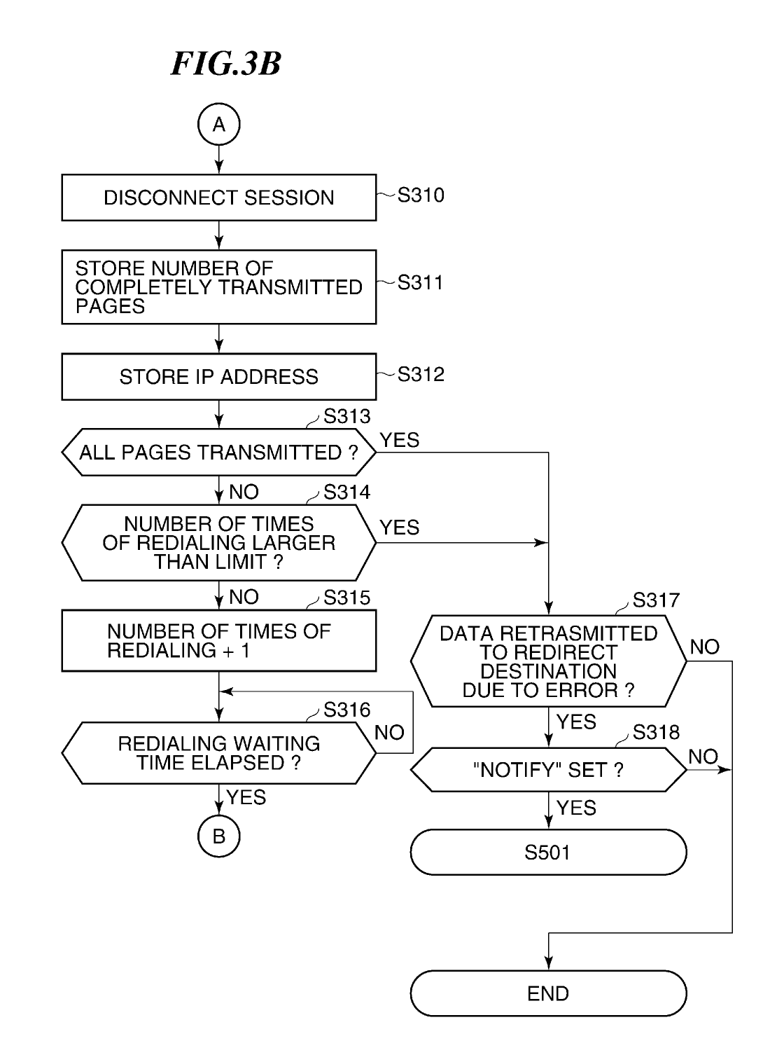

Next, a description will be given of a data transmission process executed by the MFP-X 101, including a transmission process executed when a redirect setting is made in the SIP server 104 after occurrence of an error during data transmission and before resuming the data transmission, with reference to FIGS. 3A and 3B. Processing in each step of the process in FIGS. 3A and 3B is executed e.g. by the CPU 201, by loading a control program stored in a storage unit of the MFP-X 101, such as the ROM 207 or the HDD 209, into the RAM 208.

In a step S301, the CPU 201 initializes variables, i.e. sets the number of times of redialing to 0, the received IP address to NULL, and the number of completely transmitted pages to 0, and then proceeds to a step S302.

In the step S302, the CPU 201 starts a session with the SIP server 104, and then proceeds to a step S303.

In the step S303, the CPU 201 receives the IP address of the destination from the SIP server 104, and then proceeds to a step S304.

In the step S304, the CPU 201 compares an IP address used for the immediately preceding data transmission with the IP address received in the step S303, and determines whether or not the current destination is different from the immediately preceding destination of the data transmission.

For example, if the IP address (11.11.11.11) of the MFP-A 102, received for the immediately preceding data transmission, is the same as the IP address received in the step S303, the CPU 201 determines that a redirect setting has not been made, and proceeds to a step S305 to perform a normal transmission process.

On the other hand, if the IP address (11.11.11.11) of the MFP-A 102, received for the immediately preceding data transmission, is different from the IP address received in the step S303, the CPU 201 determines that the destination has been changed, and proceeds to a step S306. In the case of originating a call, since the IP address is initialized in the step S301, the initialized IP address is different from the IP address received in the step S303, so that the CPU 201 proceeds to the step S306.

In the step S305, when a session with the destination is established, the CPU 201 proceeds to a step S309.

In the step S306, the CPU 201 determines whether or not the number of times of redialing is equal to 0, and if the number of times of redialing is equal to 0, the CPU 201 determines that a call is being originated, and then proceeds to the step S305, whereas if the number of times of redialing is not equal to 0, the CPU 201 determines that a redirect setting has been made, and then proceeds to a step S307.

In the step S307, when a session is established with a destination (redirect destination), which is different from the immediately preceding destination of the data transmission, the CPU 201 proceeds to a step S308.

In the step S308, the CPU 201 transmits the data to the redirect destination (e.g. MFP-B 103), starting from the first page, and then proceeds to a step S310.

In the step S309, the CPU 201 transmits the data to the destination of an originated call or the same destination as the immediately preceding destination of the data transmission (e.g. MFP-A 102), starting from a page next to the completely transmitted pages, and then proceeds to the step S310. In the case of an originated call, the number of completely transmitted pages is initialized in the step S301, and hence the data is transmitted starting from the first page.

In the step S310, the CPU 201 disconnects the session, and then proceeds to a step S311.

In the step S311, the CPU 201 stores the number of completely transmitted pages, and then proceeds to a step S312. The number of completely transmitted pages stored in this step is used when data retransmission is performed due to occurrence of an error.

In the step S312, the CPU 201 stores the IP address, and then proceeds to a step S313. The IP address stored in the step S312 is used as the IP address used for the immediately preceding data transmission when the CPU 201 performs the IP address comparison in the step S304.

In the step S313, the CPU 201 determines whether or not all of the pages have been transmitted, and if all of the pages have been transmitted, the CPU 201 proceeds to a step S317, whereas if not, the CPU 201 proceeds to a step S314.

In the step S314, the CPU 201 determines whether or not the number of times of redialing exceeds a predetermined limit, and if the number of times of redialing exceeds the predetermined limit, the CPU 201 proceeds to the step S317, whereas if not, the CPU 201 proceeds to a step S315.

In the step S315, the CPU 201 increments the number of times of redialing by 1, and then proceeds to a step S316.

In the step S316, the CPU 201 monitors whether or not waiting time for redialing has elapsed, and if the waiting time for redialing has elapsed, the CPU 201 returns to the step S302 to start a session again.

In the step S317, the CPU 201 determines whether or not data retransmission to a redirect destination has been performed after occurrence of an error, and if the data retransmission has been performed, the CPU 201 proceeds to a step S318, whereas if not, the CPU 201 terminates the present process.

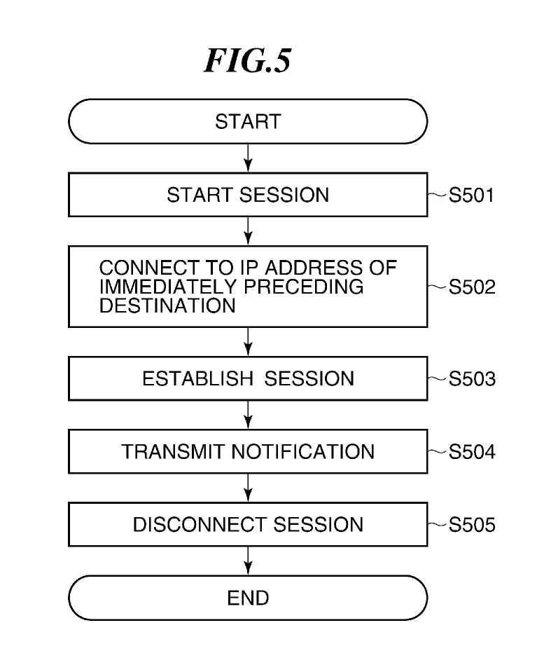

In the step S318, the CPU 201 determines based on user settings configured on a setting screen of the display/operation section 202 whether or not to notify the immediately preceding destination of the data transmission that the data has been transmitted to the redirect destination, and if the immediately preceding destination of the data transmission is to be notified that the data has been transmitted to the redirect destination, the CPU 201 proceeds to a step S501 in FIG. 5, whereas if not, the CPU 201 terminates the present process.

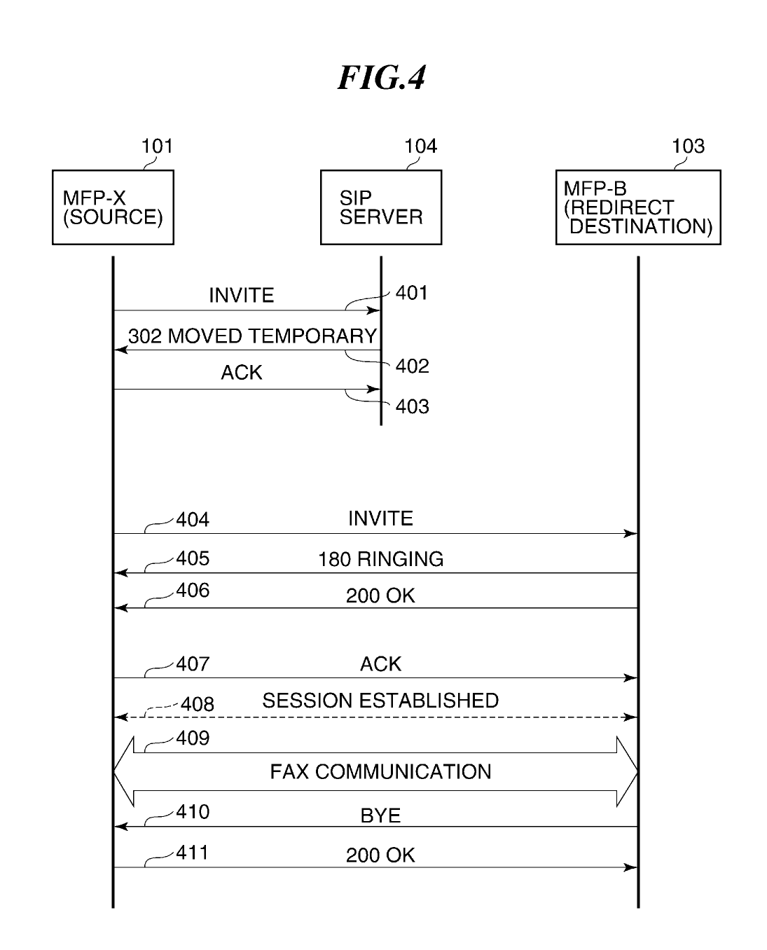

Next, a description will be given of processing executed by the MFP-X 101, for receiving a redirect setting status from the SIP server 104 and transmitting data to a redirect destination, starting from the first page, with reference to FIG. 4.

First, the MFP-X 101 sends an INVITE request to establish a session with the FAX number “03-1111-1111” of the MFP-A 102 which is the immediately preceding destination of the data transmission, to the SIP server 104 (401).

In response to the INVITE request sent from the MFP-X 101, the SIP server 104 sends a 302 Moved Temporary response (redirect response) to the MFP-X 101 (402).

At this time, the SIP server 104 refers to redirect destination setting information, and sends not only the 302 Moved Temporary response but also the IP address of the redirect destination terminal for the FAX number “03-1111-1111” of the MFP-A 102, to the MFP-X 101.

In this case, an IP address “11.11.11.22” of the MFP-B 103 which is set to the redirection destination of the data transmission is sent back to the MFP-X 101.

Then, the MFP-X 101 transmits ACK to the SIP server 104, which acknowledges the receipt of the 302 Moved Temporary response sent therefrom (403).

Upon receipt of the 302 Moved Temporary response and the IP address of the redirect destination terminal, the MFP-X 101 transmits, to the IP address “11.11.11.22” of the MFP-B 103 which is the redirect destination, an INVITE request to establish a session therewith (404).

Upon receipt of the INVITE request from the MFP-X 101, the MFP-B 103 starts a FAX reception process, and sends a 180 Ringing response, which indicates that a callee is being alerted, to the MFP-X 101 (405).

The MFP-B 103 starts receiving FAX, and sends a 200 OK response to the MFP-X 101 (406).

Upon receipt of the 200 OK response, the MFP-X 101 sends ACK acknowledging the receipt of the 200 OK response to the MFP-B 103 (407).

The reception of ACK by the MFP-B 103 establishes the session between the MFP-X 101 and the MFP-B 103 (408), whereafter real-time FAX communication starting from the first page is performed according to ITU-T Recommendation T.38 (409).

After completing FAX reception, the MFP-B 103 transmits a BYE method to the MFP-X 101 (410).

In response to this BYE method, the MFP-X 101 sends a 200 OK response to the MFP-B 103, followed by terminating the session (411).

Next, a description will be given of a process executed by the MFP-X 101, for notifying the MFP-A 102 which is the immediately preceding destination of the data transmission that the data has been transmitted to the MFP-B 103 which is the redirect destination, starting from the first page, with reference to FIG. 5. This process is executed following the step S318 in FIG. 3B, and the first step S501 is illustrated in FIG. 3B. Processing in each step of the process in FIG. 5 is executed e.g. by the CPU 201, by loading a control program stored in a storage unit of the MFP-X 101, such as the ROM 207 or the HDD 209, into the RAM 208.

In the step S501, the CPU 201 starts a session with the MFP-A 102 which is the immediately preceding destination of the data transmission, and then proceeds to a step S502.

In the step S502, the CPU 201 directly connects to the IP address (11.11.11.11) of the MFP-A 102, and then proceeds to a step S503.

In the step S503, when the session with the MFP-A 102 is established, the CPU 201 proceeds to a step S504.

In the step S504, the CPU 201 transmits message data for notifying that the data has been transmitted to the MFP-B 103 starting from the first page to the MFP-A 102, and then proceeds to a step S505.

In the step S505, the CPU 201 disconnects the session with the MFP-A 102, followed by terminating the present process.

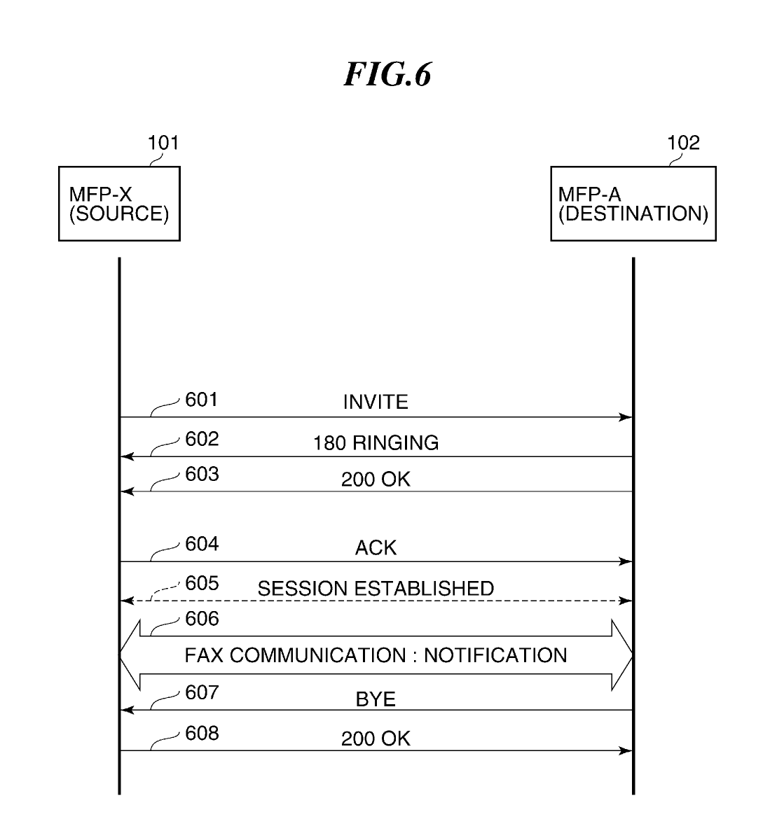

FIG. 6 is a sequence diagram useful in more specifically explaining processing described with reference to FIG. 5, which is executed for notifying the MFP-A 102 which is the immediately preceding destination of the data transmission from the MFP-X 101 that the data has been transmitted to the MFP-B 103 which is the redirect destination, starting from the first page.

First, since the IP address has been known, the MFP-X 101 sends to the MFP-A 102 an INVITE request to establish a session therewith (601).

Upon receipt of the INVITE request, the MFP-A 102 starts a FAX reception process, and sends a 180 Ringing response, which indicates that a callee is being alerted, to the MFP-X 101 (602).

The MFP-A 102 starts receiving FAX, and sends a 200 OK response to the MFP-X 101 (603).

Upon receipt of the 200 OK response, the MFP-X 101 sends ACK acknowledging the receipt of the 200 OK response to the MFP-A 102 (604).

The reception of ACK by the MFP-A 102 establishes the session between the MFP-X 101 and the MFP-A 102 (605).

Thereafter, real-time FAX communication is performed according to ITU-T Recommendation T.38, and the FAX data of a message saying e.g. that “All pages have been transmitted to redirect destination MFP-B 103” is transmitted to the MFP-A 102 (606).

After completing FAX reception, the MFP-A 102 transmits a BYE method to the MFP-X 101 (607).

In response to this BYE method, the MFP-X 101 sends a 200 OK response to the MFP-A 102, followed by terminating the session (608).

As described above, in the present embodiment, when a redirect setting is made after occurrence of an error during data transmission and before resuming the data transmission, the data is transmitted again to the redirect destination, starting from the first page, and hence it is possible to receive the data in a state of the complete set of pages without being divided. Further, the immediately preceding destination of the data transmission is also notified that all of the pages of the data have been transmitted to the redirect destination, and hence the whereabouts of the received data is made clear. This makes it possible to prevent a user of the terminal which has received the data from being confused.

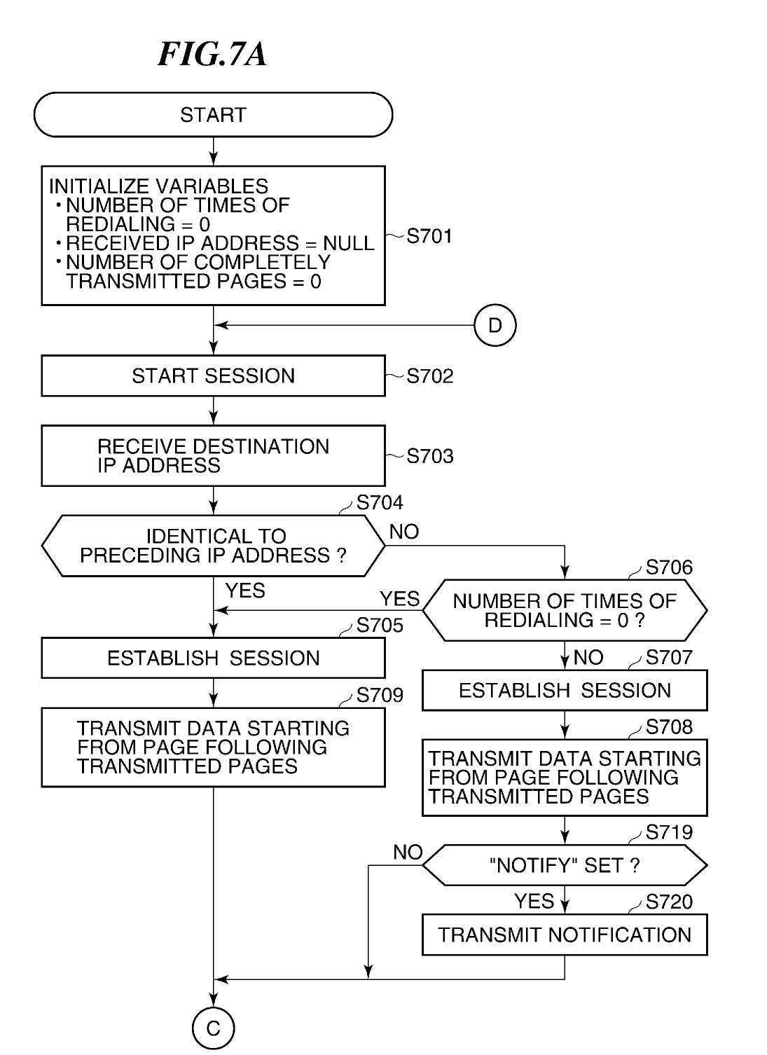

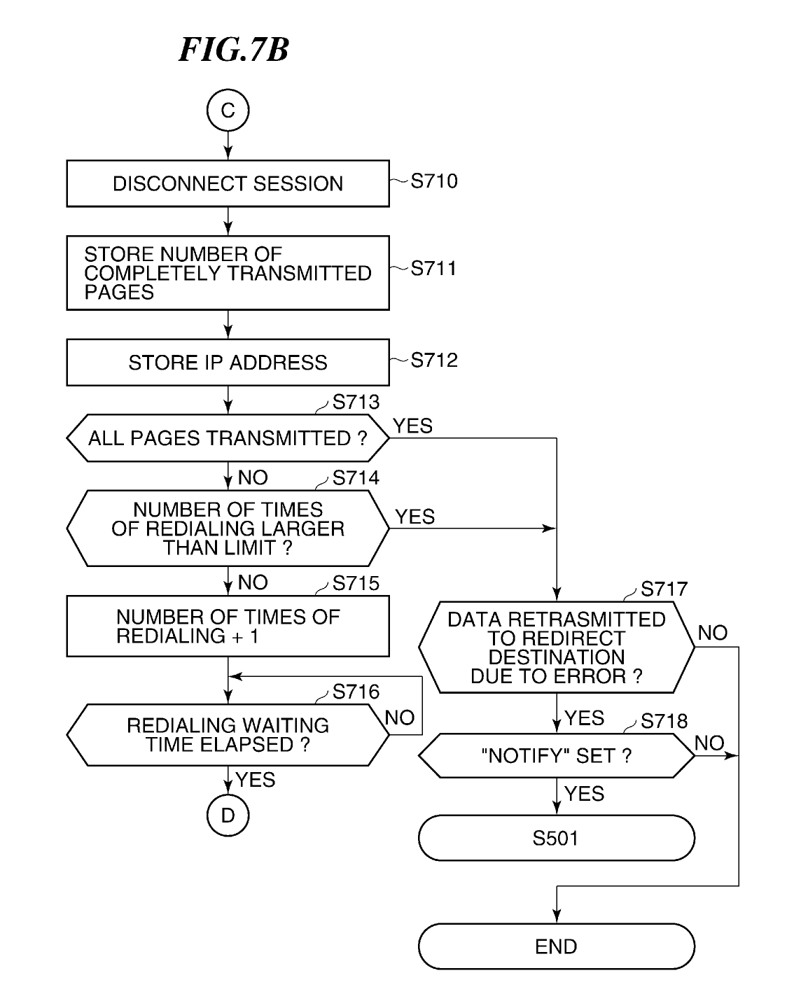

Next, a description will be given of a communication terminal according to a second embodiment of the present invention with reference to FIGS. 7A and 7B. It should be noted that component parts and elements identical or corresponding to those of the first embodiment will be denoted by identical reference numerals, and description thereof will be given using the figures with reference to which the first embodiment is described.

FIGS. 7A and 7B are a flowchart of a transmission process executed by the MFP-X 101, including a transmission process executed in a case where a redirect setting is made in the SIP server 104 after occurrence of an error during data transmission and before resuming the data transmission. Processing in each step of the process in FIGS. 7A and 7B is executed e.g. by the CPU 201, by loading a control program stored in a storage unit of the MFP-X 101, such as the ROM 207 or the HDD 209, into the RAM 208.

It should be noted that steps S701 to S707 and steps S709 to S718 in FIGS. 7A and 7B are the same as the steps S301 to S307 and the steps S309 to S318 in FIGS. 3A and 3B with reference to which the first embodiment is described, and hence description thereof is omitted.

When a session with a destination (redirect destination) different from the immediately preceding destination of the data transmission is established in the step S707, in a step S708, the CPU 201 transmits data to the redirect destination (e.g. MFP-B 103) starting from a page next to the completely transmitted pages, and then proceeds to a step S719.

In the step S719, the CPU 201 determines whether or not to notify the redirect destination that the preceding data part has been transmitted to the destination in use before the redirect setting was made, based on the user settings configured on the setting screen of the display/operation section 202. Then, if the CPU 201 is to notify the redirect destination that the preceding data part has been transmitted to the destination in use before the redirect setting was made, the CPU 201 proceeds to the step S720, whereas if not, the CPU 201 proceeds to a step S710.

In the step S720, the CPU 201 transmits the FAX data of a message notifying that “The preceding data part has been transmitted to the immediately preceding destination of the data transmission in use before the redirect setting was made” to the redirect destination, and then proceeds to the step S710.

It should be noted that if it is determined in the step S718 that the data retransmission to the redirect destination is to be notified and hence the CPU 201 proceeds to the step S501, in the step S504 in FIG. 5, the CPU 201 transmits FAX data to the MFP-A 102, for notifying that data has been transmitted to the MFP-B 103 starting from a page next to the completely transmitted pages.

As described above, in the present embodiment, when a redirect setting is made after occurrence of an error during data transmission and before resuming the data transmission, data starting from a page next to the completely transmitted pages is transmitted to the redirect destination. Further, the redirect destination is notified that the preceding data part has been transmitted to the immediately preceding destination of the data transmission in use before the redirect setting was made (first notification), and the immediately preceding destination of the data transmission is notified that the following data part has been transmitted to the redirect destination (second notification). This makes it possible to prevent a user of the terminal which has received data from being confused.

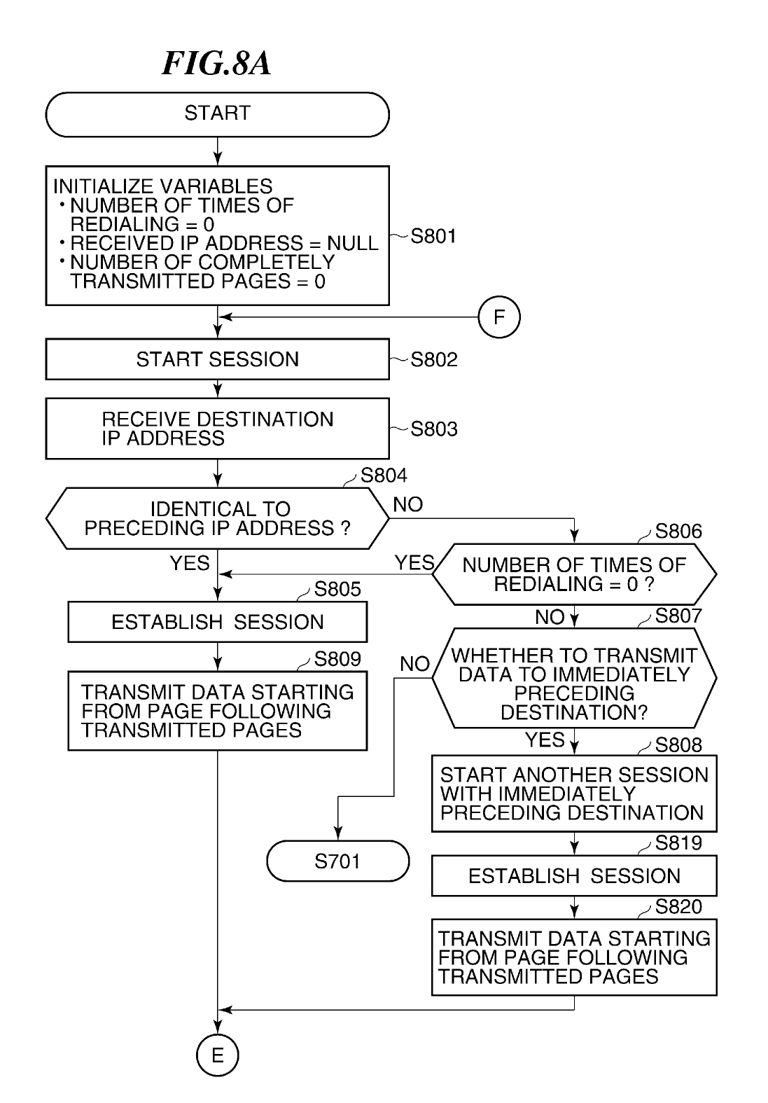

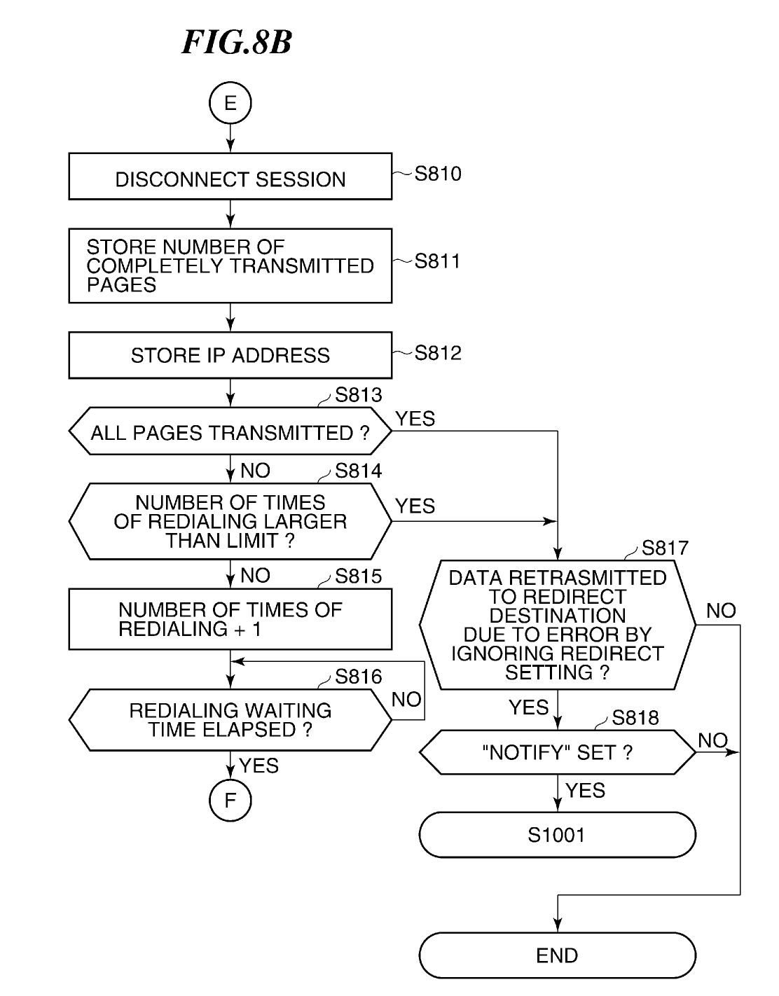

Next, a description will be given of a communication terminal according to a third embodiment of the present invention with reference to FIGS. 8A to 11. It should be noted that component parts and elements identical or corresponding to those of the first embodiment will be denoted by identical reference numerals, and description thereof will be given using the figures with reference to which the first embodiment is described.

FIGS. 8A and 8B are a flowchart of a transmission process executed by an MFP-X 101, including a transmission process executed in a case where a redirect setting is made in the SIP server 104 after occurrence of an error during data transmission and before resuming the data transmission. Processing in each step of the process in FIGS. 8A and 8B is executed e.g. by the CPU 201, by loading a control program stored in a storage unit of the MFP-X 101, such as the ROM 207 or the HDD 209, into the RAM 208.

It should be noted that steps S801 to S806 and steps S809 to S816 in FIGS. 8A and 8B are the same as the steps S301 to S306 and the steps S309 to S316 in FIGS. 3A and 3B with reference to which the first embodiment is described, and hence description thereof is omitted.

If it is determined in the step S806 that the number of times of redialing is not equal to 0, and hence it is determined that a redirect setting has been made, the CPU 201 determines in a step S807 whether or not to transmit the following data part to the immediately preceding destination of the data transmission without transmitting any data to the redirect destination. Then, if the CPU 201 is to transmit the following data part to the immediately preceding destination of the data transmission, the CPU 201 proceeds to a step S808, whereas if not, the CPU 201 proceeds to the step S701 in FIG. 7A.

In the step S808, the CPU 201 starts a session with the immediately preceding destination of the data transmission again to thereby directly connect to the IP address (11.11.11.11) of the MFP-A 102, and then proceeds to a step S819.

In the step S819, when the session started in the step S808 is established, the CPU 201 proceeds to a step S820.

In the step S820, the CPU 201 transmits data starting from a page next to the completely transmitted pages, i.e. the following data part to the immediately preceding destination of the data transmission, and then proceeds to the step S810.

Further, in a step S817, the CPU 201 determines whether or not the following data part has been transmitted to the immediately preceding destination of the data transmission by ignoring the redirect setting, and if the following data part has been transmitted, the CPU 201 proceeds to a step S818, whereas if not, the CPU 201 terminates the present process.

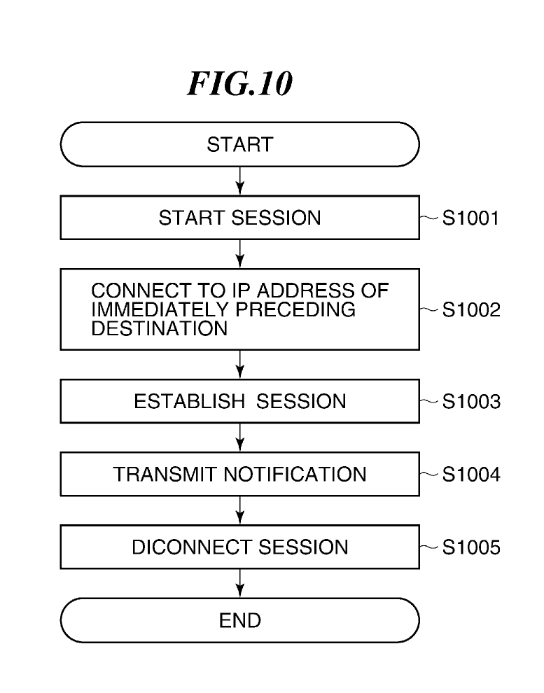

In the step S818, the CPU 201 determines based on the user settings configured on the setting screen of the display/operation section 202 whether or not to notify the redirect destination that the data retransmission to the immediately preceding destination of the data transmission has been performed by ignoring the redirect setting, and if the redirect destination is to be notified, the CPU 201 proceeds to a step S1001 in FIG. 10, whereas if not, the CPU 201 terminates the present process.

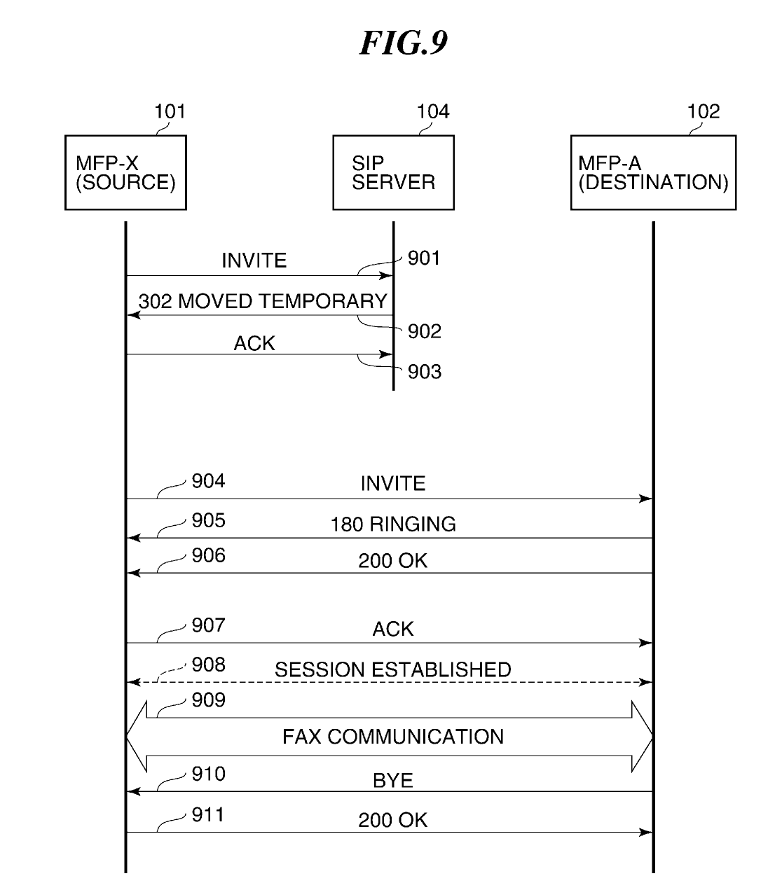

FIG. 9 is a sequence diagram useful in explaining processing executed for transmitting data from the MFP-X 101 to the MFP-A 102 which is the immediately preceding destination of the data transmission, starting from a page next to the completely transmitted pages, if a redirect setting is made after occurrence of an error during data transmission and before resuming the data transmission.

First, the MFP-X 101 sends an INVITE request to establish a session with the FAX number “03-1111-1111” of the MFP-A 102 which is the immediately preceding destination of the data transmission, to the SIP server 104 (901).

In response to the INVITE request sent from the MFP-X 101, the SIP server 104 sends a 302

Moved Temporary response (redirect response) which indicates that a redirect setting has been made to redirect data to the MFP-B 103 which is a redirect destination, to the MFP-X 101 (902).

Then, the MFP-X 101 transmits to the SIP server 104 ACK acknowledging the receipt of the 302 Moved Temporary response sent from the SIP server 104 (903).

The MFP-X 101 sends to the IP address “11.11.11.11” of the MFP-A 102 which is the immediately preceding destination of the data transmission an INVITE request to establish a session therewith (904).

Upon receipt of the INVITE request, the MFP-A 102 starts a FAX reception process, and sends a 180 Ringing response, which indicates that a callee is being alerted, to the MFP-X 101 (905).

The MFP-A 102 starts receiving FAX, and sends a 200 OK response to the MFP-X 101 (906).

Upon receipt of the 200 OK response, the MFP-X 101 sends ACK acknowledging the receipt of the 200 OK response to the MFP-A 102 (907).

The reception of ACK by the MFP-A 102 establishes the session between the MFP-X 101 and the MFP-A 102 (908).

Thereafter, real-time FAX communication is performed according to ITU-T Recommendation T.38 from the MFP-X 101 to the MFP-A 102 which is the immediately preceding destination of the data transmission, starting from a page next to the completely transmitted pages (909).

After completing FAX reception, the MFP-A 102 transmits a BYE method to the MFP-X 101 (910).

In response to this BYE method, the MFP-X 101 transmits a 200 OK response to the MFP-A 102, followed by terminating the session (911).

Next, a description will be given of a process executed by the MFP-X 101, for notifying the MFP-B 103 which is the redirect destination that data has been transmitted to the MFP-A 102 which is the immediately preceding destination of the data transmission, starting from a page next to the completely transmitted pages. This process is executed following the step S818 in FIG. 8B, and the first step S1001 is illustrated in FIG. 8B. Processing in each step of the process in FIG. 10 is executed e.g. by the CPU 201, by loading a control program stored in a storage unit of the MFP-X 101, such as the ROM 207 or the HDD 209, into the RAM 208.

In the step S1001, the CPU 201 starts a session with the MFP-B 103 which is the redirect destination, and then proceeds to a step S1002.

In the step S1002, the CPU 201 directly connects to the IP address (11.11.11.22) of the MFP-B 103, and then proceeds to a step S1003.

In the step S1003, when the session with the MFP-B 103 is established, the CPU 201 proceeds to a step S1004.

In the step S1004, the CPU 201 transmits FAX data to the MFP-B 103, for notifying that data has been transmitted to the MFP-A 102 which is the immediately preceding destination of the data transmission, starting from a page next to the completely transmitted pages, and then proceeds to a step S1005. Examples of notification include a massage saying that “Destination is changed due to error during transmission, but to prevent remaining pages from becoming separate from transmitted pages, remaining pages have also been transmitted to preceding destination”.

In the step S1005, the CPU 201 disconnects the session with the MFP-B 103, followed by terminating the present process.

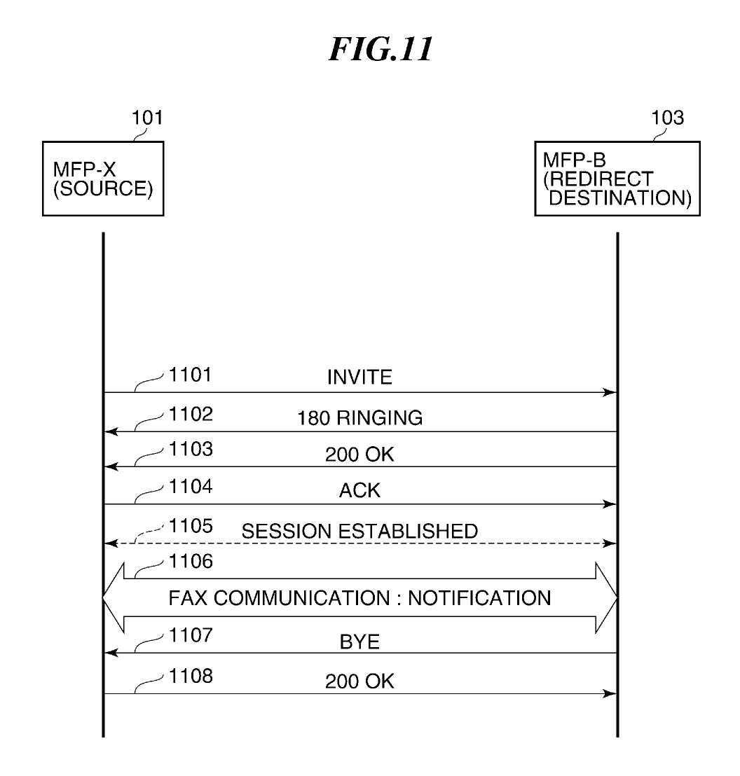

FIG. 11 is a sequence diagram useful in explaining processing executed for notifying the MFP-B 103 which is the redirect destination from the MFP-X 101 that data has been transmitted to the MFP-A 102 which is the immediately preceding destination of the data transmission, starting from a page next to the completely transmitted pages.

First, the MFP-X 101 sends to the MFP-B 103 an INVITE request to establish a session therewith (1101).

Upon receipt of the INVITE request, the MFP-B 103 starts a FAX reception process, and sends a 180 Ringing response, which indicates that a callee is being alerted, to the MFP-X 101 (1102).

The MFP-B 103 starts receiving FAX, and sends a 200 OK response to the MFP-X 101 (1103).

Upon receipt of the 200 OK response, the MFP-X 101 sends ACK acknowledging the receipt of the 200 OK response to the MFP-B 103 (1104).

The reception of ACK by the MFP-B 103 establishes the session between the MFP-X 101 and the MFP-B 103 (1105).

Thereafter, real-time FAX communication is performed according to ITU-T Recommendation T.38 (1106). Here, FAX data of a message saying e.g. that “Destination is changed due to error during transmission, but to prevent remaining pages from becoming separate from transmitted pages, remaining pages have also been transmitted to preceding destination” is transmitted to the MFP-B 103.

After completing FAX reception, the MFP-B 103 transmits a BYE method to the MFP-X 101 (1107).

In response to this BYE method, the MFP-X 101 transmits a 200 OK response to the MFP-B 103, followed by terminating the session (1108).

As described above, in the present embodiment, when a redirect setting is made after occurrence of an error during data transmission and before resuming the data transmission, the data is transmitted not to the redirect destination, but to the immediately preceding destination of the data transmission, starting from a page next to the completely transmitted pages. Further, the redirect destination is notified that the following data part has been transmitted to the immediately preceding destination of the data transmission in use before the redirect setting was made. This makes it possible to prevent a user of the terminal which has received the data from being confused.

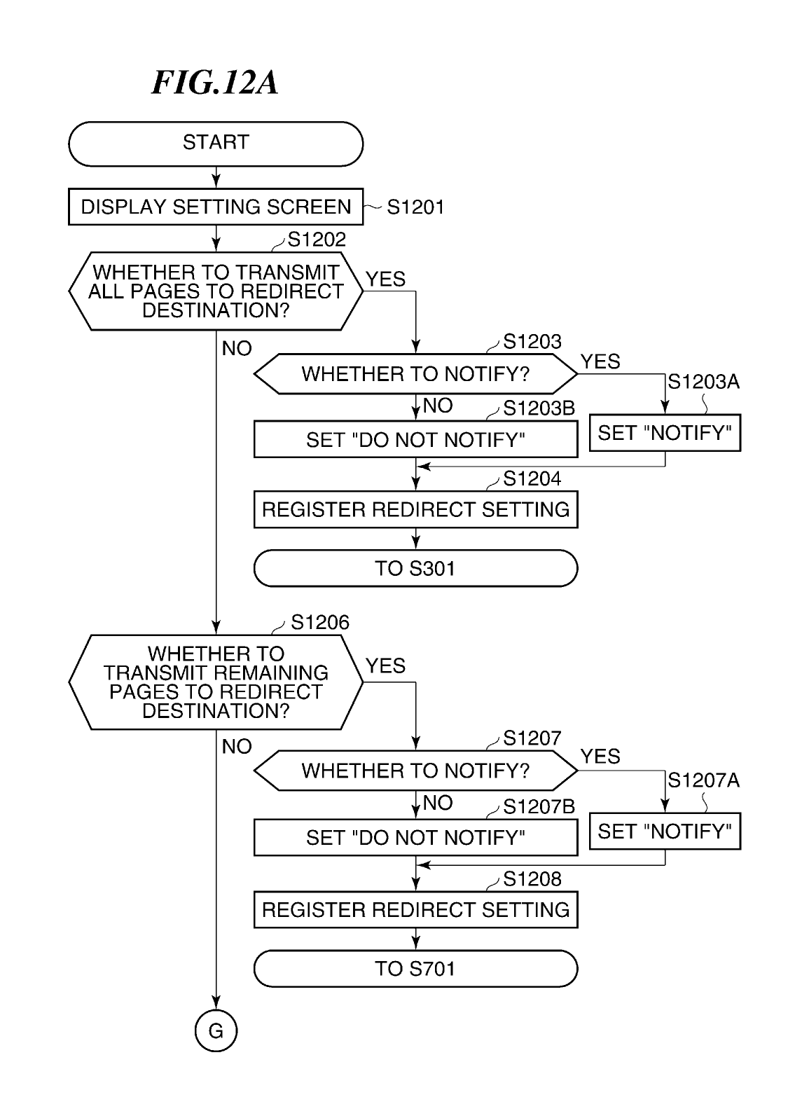

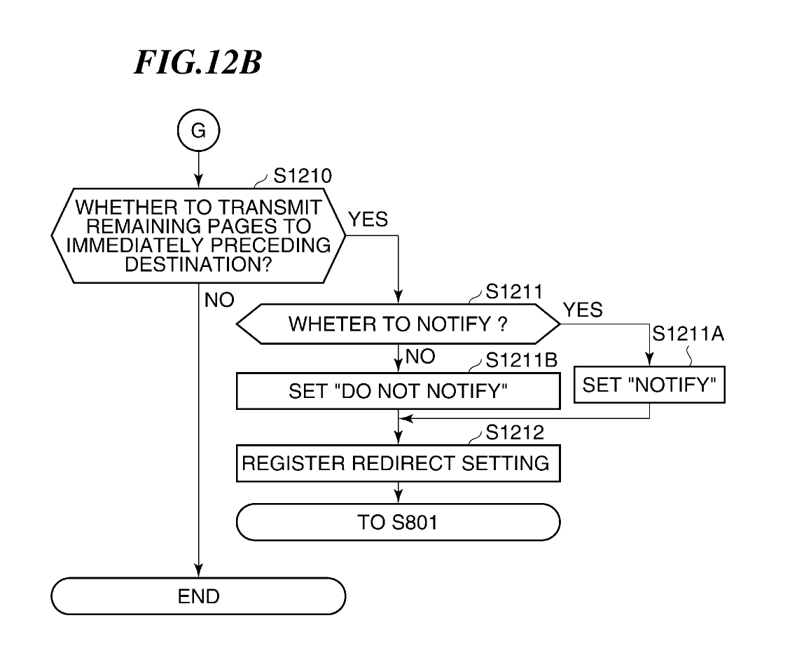

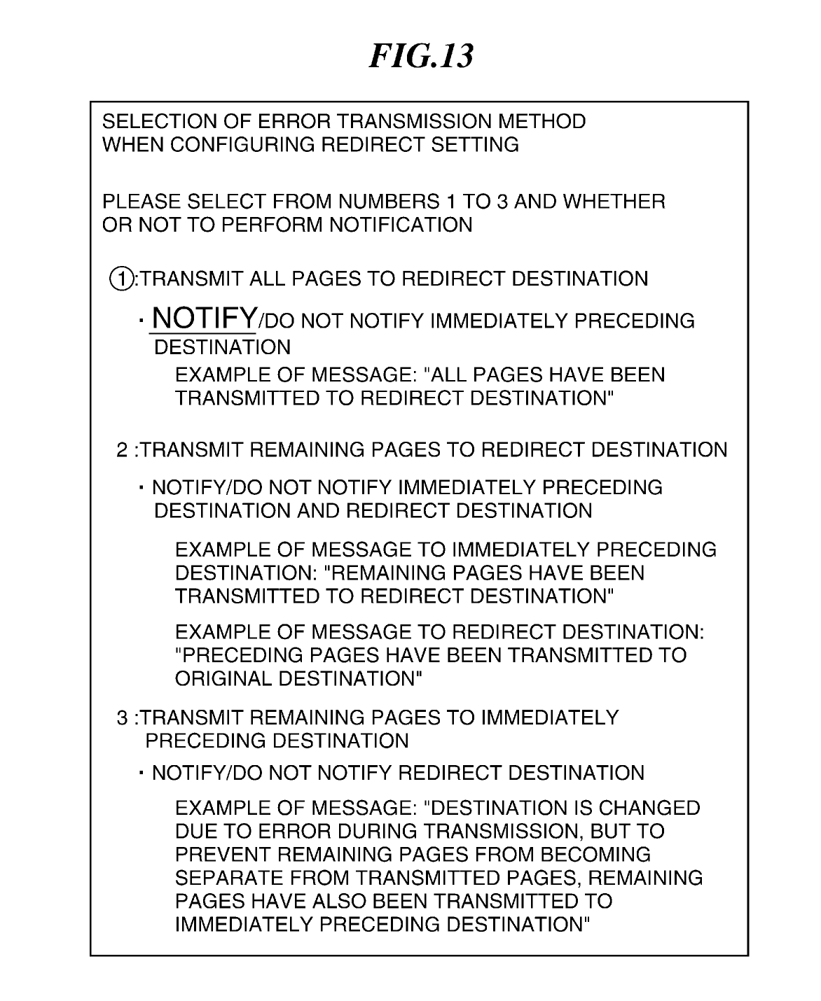

Next, a description will be given of a communication terminal according to a fourth embodiment of the present invention with reference to FIGS. 12A, 12B and 13. It should be noted that component parts and elements identical or corresponding to those of the first embodiment will be denoted by identical reference numerals, and description thereof will be given using the figures with reference to which the first embodiment is described.

FIGS. 12A and 12B are a flowchart useful in explaining an example of the operation of a communication terminal according to a fourth embodiment of the present invention. Processing in each step of the process in FIGS. 12A and 12B is executed e.g. by the CPU 201, by loading a control program stored in a storage unit of the MFP-X 101, such as the ROM 207 or the HDD 209, into the RAM 208.

Referring to FIGS. 12A and 12B, in a step S1201, the CPU 201 displays the setting screen illustrated in FIG. 13, by way of example, on the display/operation section 202, and then proceeds to a step S1202.

In the step S1202, the CPU 201 determines whether or not “1: transmit all pages to redirect destination” is selected by a user operation on the setting screen in FIG. 13, and if “1: transmit all pages to redirect destination” is selected, the CPU 201 proceeds to a step S1203, whereas if not, the CPU 201 proceeds to a step S1206. It should be noted that the example illustrated in FIG. 13 displays the case where “1: transmit all pages to redirect destination” is selected.

In the step S1203, the CPU 201 determines whether “Notify immediately preceding destination” or “Do not notify immediately preceding destination” is selected by a user operation on the setting screen in FIG. 13. Then, if “Notify immediately preceding destination” is selected, the CPU 201 proceeds to a step S1203A, wherein the CPU 201 sets the redirect setting to “Notify immediately preceding destination”, and then the CPU 201 proceeds to a step S1204, whereas if “Do not notify immediately preceding destination” is selected, the CPU 201 proceeds to a step S1203B, wherein the CPU 201 sets the redirect setting to “Do not notify immediately preceding destination”, and then the CPU 201 proceeds to the step S1204.

In the step S1204, the CPU 201 registers the redirect setting set in the step S1203A or S1203B, and then the CPU 201 proceeds to the step S301 in FIG. 3A to execute the process in FIGS. 3A and 3B.

In the step S1206, the CPU 201 determines whether or not “2: Transmit remaining pages to redirect destination” is selected by a user operation on the setting screen in FIG. 13, and if “2: Transmit remaining pages to redirect destination” is selected, the CPU 201 proceeds to a step S1207, whereas if not, the CPU 201 proceeds to a step S1210.

In the step S1207, the CPU 201 determines whether “Notify immediately preceding destination and redirect destination” or “Do not notify immediately preceding destination or redirect destination” is selected by a user operation on the setting screen in FIG. 13. Then, if “Notify immediately preceding destination and redirect destination” is selected, the CPU 201 proceeds to a step S1207A, wherein the CPU 201 sets the redirect setting to “Notify immediately preceding destination and redirect destination”, and then proceeds to a step S1208, whereas if “Do not notify immediately preceding destination or redirect destination” is selected, the CPU 201 proceeds to a step S1207B, wherein the CPU 201 sets the redirect setting to “Do not notify immediately preceding destination or redirect destination”, and then proceeds to the step S1208.

In the step S1208, the CPU 201 registers the redirect setting set in the step S1207A or S1207B, and then the CPU 201 proceeds to the step S701 in FIG. 7A to execute the process in FIGS. 7A and 78.

In the step S1210, the CPU 201 determines whether or not “3: Transmit remaining pages to immediately preceding destination” is selected by a user operation on the setting screen in FIG. 13, and if “3: Transmit remaining pages to immediately preceding destination” is selected, the CPU 201 proceeds to a step S1211, whereas if not, the CPU 201 terminates the present process.

In the step S1211, the CPU 201 determines whether “Notify redirect destination” or “Do not notify redirect destination” is selected by a user operation on the setting screen in FIG. 13. Then, if “Notify redirect destination” is selected, the CPU 201 proceeds to a step S1211A, wherein the CPU 201 sets the redirect setting to “Notify redirect destination”, and then proceeds to a step S1212, whereas if “Do not notify redirect destination” is selected, the CPU 201 proceeds to a step S1211B, wherein the CPU 201 sets the redirect setting to “Do not notify redirect destination”, and then proceeds to the step S1212.

In the step S1212, the CPU 201 registers the redirect setting set in the step S1211A or S1211B, and then the CPU 201 proceeds to the step S801 in FIG. 8A to execute the process in FIGS. 8A and 8B.

As described above, in the present embodiment, it is possible to select between the transmission processes in the first embodiment (FIGS. 3A and 3B), the second embodiment (FIGS. 7A and 7B), and the third embodiment (FIGS. 8A and 8B) by a user operation on the setting screen.

Further, it is to be understood that the present invention may also be accomplished by supplying a system or an apparatus with a storage medium in which a program code of software, which realizes the functions of the above described embodiment, is stored, and causing a computer (or CPU or MPU) of the system or apparatus to read out and execute the program code stored in the storage medium.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of

Japanese Patent Application No. 2009-172208, filed Jul. 23, 2009, which is hereby incorporated by reference herein in its entirety.

What is claimed is:

1. A communication terminal that performs data transmission using a session initiation protocol, comprising:
a determination unit adapted to determine, based on address information received before resuming the data transmission, whether or not a redirect setting has been made after occurrence of an error during data transmission; and
a control unit adapted to transmit data to a terminal of a redirect destination of the data transmission, starting from a first page, in a case where when resuming the data transmission, said determination unit determines that the redirect setting has been made.

2. The communication terminal according to claim 1, further comprising a notification unit adapted to be operable when data is transmitted by said control unit to the terminal of the redirect destination, starting from the first page, to notify a terminal of an immediately preceding destination of the data transmission.

3. A communication terminal which performs data transmission using a session initiation protocol, comprising:
a determination unit adapted to determine, based on address information received before resuming the data transmission, whether or not a redirect setting has been made after occurrence of an error during data transmission;
a control unit adapted to transmit data to a terminal of a redirect destination of the data transmission, starting from a page next to completely transmitted pages, in a case where when resuming the data transmission, said determination unit determines that the redirect setting has been made;
a first notification unit adapted to be operable when said control unit has transmitted the data to the terminal of the redirect destination of the data transmission, starting from the page next to the completely transmitted pages, to notify the terminal of the redirect destination of the data transmission that data of preceding pages has been transmitted to a terminal of an immediately preceding destination of the data transmission; and
a second notification unit adapted to be operable when said control unit has transmitted the data to the terminal of the redirect destination of the data transmission, starting from the page next to the completely transmitted pages, to notify the terminal of the immediately preceding destination of the data transmission that data of following pages has been transmitted to the terminal of the redirect destination of the data transmission.

4. A communication terminal that performs data transmission using a session initiation protocol, comprising:
a determination unit adapted to determine, based on address information received before resuming the data transmission, whether or not a redirect setting has been made after occurrence of an error during data transmission;
a control unit adapted to transmit data to a terminal of an immediately preceding destination of the data transmission, starting from a page next to completely transmitted pages, in a case where when resuming the data transmission, said determination unit determines that the redirect setting has been made; and
a notification unit adapted to be operable when said control unit has transmitted the data to the terminal of the immediately preceding destination of the data transmission, starting from the page next to the completely transmitted pages, to notify a terminal of a redirect destination of the data transmission that data of following pages has been transmitted to the terminal of the immediately preceding destination of the data transmission.

5. A communication method for performing data transmission using a session initiation protocol, comprising:
determining, based on address information received before resuming the data transmission, whether or not a redirect setting has been made after occurrence of an error during data transmission; and
transmitting data to a terminal of a redirect destination of the data transmission, starting from a first page, in a case where when resuming the data transmission, it is determined that the redirect setting has been made.

6. A communication method for performing data communication using a session initiation protocol, comprising:
determining, based on address information received before resuming the data transmission, whether or not a redirect setting has been made after occurrence of an error during data transmission;
transmitting data to a terminal of a redirect destination of the data transmission, starting from a page next to completely transmitted pages, in a case where when resuming the data transmission, it is determined that the redirect setting has been made;
notifying, when the data has been transmitted to the terminal of the redirect destination, starting from the page next to the completely transmitted pages, the terminal of the redirect destination of the data transmission that data of preceding pages has been transmitted to a terminal of an immediately preceding destination of the data transmission; and
notifying, when the data has been transmitted to the terminal of the redirect destination, starting from the page next to the completely transmitted pages, the terminal of the immediately preceding destination of the data transmission that data of following pages has been transmitted to the terminal of the redirect destination of the data transmission.

7. A communication method of performing data communication using a session initiation protocol, comprising:
determining, based on address information received before resuming the data transmission, whether or not a redirect setting has been made after occurrence of an error during data transmission;
transmitting data to a terminal of an immediately preceding destination of the data transmission, starting from a page next to completely transmitted pages, in a case where when resuming the data transmission, it is determined that the redirect setting has been made; and
notifying, when the data has been transmitted to the terminal of the immediately preceding destination of the data transmission, starting from the page next to the completely transmitted pages, a terminal of a redirect destination of the data transmission that data of following pages has been transmitted to the terminal of the immediately preceding destination of the data transmission.

8. A non-transitory computer-readable storage medium storing a program for causing a computer to execute a communication method for performing data communication using a session initiation protocol,
wherein the communication method comprises:
determining, based on address information received before resuming the data transmission, whether or not a redirect setting has been made after occurrence of an error during data transmission; and
transmitting data to a terminal of a redirect destination of the data transmission, starting from a first page, in a case where when resuming the data transmission, it is determined that the redirect setting has been made.

9. A non-transitory computer-readable storage medium storing a program for causing a computer to execute a communication method for performing data communication using a session initiation protocol,
wherein the communication method comprises:
determining, based on address information received before resuming the data transmission, whether or not a redirect setting has been made after occurrence of an error during data transmission;
transmitting data to a terminal of a redirect destination of the data transmission, starting from a page next to completely transmitted pages, in a case where when resuming the data transmission, it is determined that the redirect setting has been made;
notifying, when the data has been transmitted to the terminal of the redirect destination, starting from the page next to the completely transmitted pages, the terminal of the redirect destination of the data transmission that data of preceding pages has been transmitted to a terminal of an immediately preceding destination of the data transmission; and
notifying, when the data has been transmitted to the terminal of the redirect destination, starting from the page next to the completely transmitted pages, the terminal of the immediately preceding destination of the data transmission that data of following pages has been transmitted to the terminal of the redirect destination of the data transmission.

10. A non-transitory computer-readable storage medium storing a program for causing a computer to execute a communication method for performing data communication using a session initiation protocol,
wherein the communication method comprises:
determining, based on address information received before resuming the data transmission, whether or not a redirect setting has been made after occurrence of an error during data transmission;
transmitting data to a terminal of an immediately preceding destination of the data transmission, starting from a page next to completely transmitted pages, in a case where when resuming the data transmission, it is determined that the redirect setting has been made; and
notifying, when the data has been transmitted to the terminal of the immediately preceding destination of the data transmission, starting from the page next to the completely transmitted pages, a terminal of a redirect destination of the data transmission that data of following pages has been transmitted to the terminal of the immediately preceding destination of the data transmission.
